(19) United States
(12) Patent Application Publication
(10) Pub. No.: US 2015/0062333 A1
(43) Pub. Date: Mar. 5, 2015

(54) METHOD AND SYSTEM FOR NATURE OBSERVATION

(71) Applicant: David J. Kilner, Buckhorn (CA)

(72) Inventor: David J. Kilner, Buckhorn (CA)

(21) Appl. No.: 14/015,975

(22) Filed: Aug. 30, 2013

(51) Int. Cl. H04N 7/18

(52) U.S. Cl. CPC H04N 7/18
USPC 348/143

(57) ABSTRACT

A nature observation device has a lower housing including a camera, the camera being configured to record images of nature. The observation device may include an upper housing configured to be disposed adjacent to and on top of the lower housing, the upper housing including a transmitter and a microphone. The observation device may also include a rod with first and second coupling mechanisms, the rod being configured to extend below the housing dome and above the housing dome for connection to an existing feeder.

This application claimed priority to Provisional Application Ser. No. 61/694,295 filed Aug. 29, 2012, the contents of which are hereby incorporated by reference.

### FIELD

This application discloses methods and systems for observing nature. More specifically, this disclosure describes a wireless and electronic nature-observing system and social networking device for sharing observations.

### BACKGROUND OF THE INVENTION

Many people today observe nature for education and as a recreational activity. Observing nature often includes watching and feeding birds. Bird watching and feeding is the second largest hobby in the world and is a billion-dollar industry.

Nature may be observed with the naked eye, through visual enhancement devices such as binoculars and telescopes, or by listening for sounds. Nature observation also includes an auditory component, and many species such as birds may be more easily detected by sound rather than sight.

To more closely and efficiently observe birds and nature, users may construct bird houses or feeders that may attract different kinds of birds or animals. To observe birds at a feeder, however, a person must be physically present at the bird feeder.

Due to the difficulty of being physically present at a birdfeeder, needs exists for improved methods and systems for remotely observing birds and/or animals.

### SUMMARY

Bird feeding and viewing is one of the largest hobbies in the world. One way people observe birds and other animals in nature is by placing a bird feeder or bird house outdoors to supply birds and other animals with shelter and food. Because birds and other animals realize that food and shelter is being provided for them at a fixed location, the birds and animals may often visit the bird feeders and houses.

Embodiments described herein provide for systems and methods that allow for a nature observation device to be coupled to an existing bird feeder, house or any other apparatus. The observation device may then capture images, such as videos and pictures, as well as sounds at or near the bird feeder. The observation device may then transmit the images and sounds to a remote location where they may then be uploaded to a website or social networking site so that others all over the world may observe the sights and sounds at the feeder.

One embodiment may include a nature observation device comprising a lower housing including a camera, the camera being configured to record images of a nature. The observation device may include an upper housing configured to be disposed adjacent to and on top of the lower housing, the upper housing including a transmitter and a microphone. The observation device may also include a rod with first and second coupling mechanisms, the rod being configured to extend below the housing dome and above the housing dome.

In an embodiment, the camera is disposed on a slide bar, the slide bar being perpendicular to the rod.

In an embodiment, the slide bar is configured to allow the camera to slide along the slide bar, changing a field of view of the camera.

In an embodiment, the upper housing is secured in place via a locking mechanism.

In an embodiment, loosening the locking mechanism allows the upper housing to slide along the rod to be apart from the lower housing.

In an embodiment, an outer surface of the upper housing includes a solar charging unit, and the upper housing includes a battery, the battery configured to be charged by the solar charging unit.

In an embodiment, the upper housing is a first dome and the lower housing is a second dome, the upper housing being smaller than the lower housing.

In an embodiment, the transmitter is configured to transmit the sounds via FM radio waves or raw or encrypted RF waves to allow multiple transmitters in one location.

In an embodiment, the transmitted sounds and images are transmitted in real time, and the transmitted sounds and images are uploaded to a website in real time. These transmitted sounds and/or images may be transmitted as either raw data or encrypted data.

In one embodiment, the nature observation device may include a global positioning system (GPS) or any other locating system known in the art such as a real-time locating system (RTLS), Wi-Fi locating system, etc. Based on the location of the nature observation device, the nature observation device may transmit data to be displayed on a social networking site for social networking purposes so people know where the birds, animals and/or nature are located.

These and other aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 depicts a topology of a system including an observation device according to an embodiment.

FIG. 2 depicts an illustration of an observation device according to an embodiment.

FIG. 3 depicts a perspective view of a top dome of an observation device according to an embodiment.

FIGS. 4A-C depict a various views of a top dome of an observation device according to an embodiment.

FIG. 5 depicts a perspective view of a first dome and a second dome according to an embodiment.

FIG. 6 depicts a housing for a slide bar according to an embodiment.

FIG. 7 depicts a camera attached to a slide bar according to one embodiment.

FIG. 8 depicts an observation device with threaded screw locking mechanisms according to one embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items, and “or” is inclusive, such that “A or B” is satisfied by just A, just B, or a combination of A and B.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Bird feeding and viewing is the second largest hobby in the world. Last year, at least six billion dollars were spent in the bird feeding market alone. One way people observe birds and other animals in natures is by placing a bird feeder or bird house outdoors to supply birds and other animals with shelter and food. Because birds and other animals realize that food and shelter is being provided for them at a fixed location, the birds and animals may often visit the bird feeders and houses. As such, users may visit the feeders and houses to observe the birds and other animals.

Embodiments described herein provide for a system and method that allow for a nature observation device to be coupled to an existing bird feeder, house or another apparatus. The observation device may then capture images, such as videos and pictures, as well as sounds at or near the bird feeder. The observation device may then transmit the images and sounds to a remote receiver, where they may then be uploaded to a website or social networking site so that others at remote locations may be able to observe the sights and sounds at the feeder.

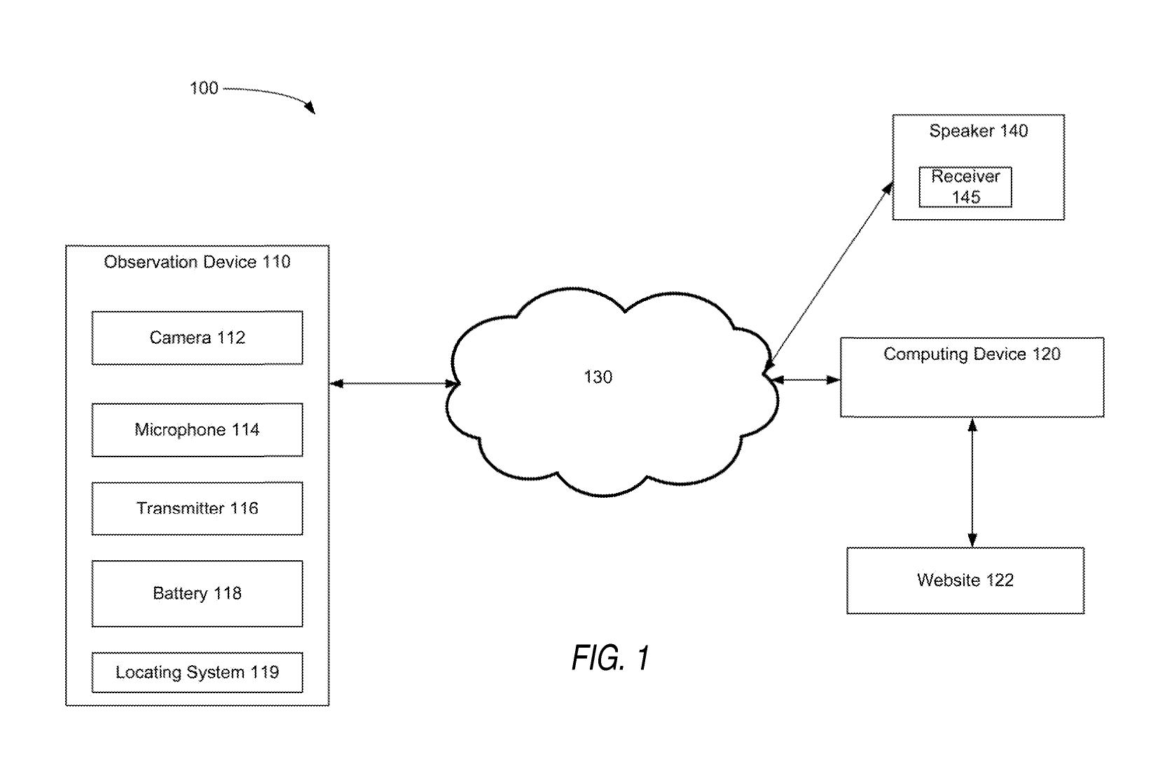

Turning now to FIG. 1, a topology 100 of a system including an observation device 110 which is coupled to computing device 120 through network 130 is depicted. Network 130 may be for example, a wireless network, wired network, or a combination, communications network such as the Internet, wide area network (WAN), general packet radio service (GPRS), enhanced data rate (EDGE system), FM radio, AM radio, or any other type of electronic communications link.

Observation device 110 may be an apparatus that is configured to be coupled to a feeder or housing, such as a bird feeder or bird house. For the sake of brevity, the term “feeder” as used herein may describe any type of existing feeder or housing. In one embodiment, observation device 110 may be configured to be disposed on top of an existing feeder, such that observation device 110 may observe activity at the feeder. Observation device 110 may be comprised of UV resistant PVC, plastics, or any other rigid material, and include camera 112, recorder 114, transmitter 116, battery 118 and/or locating system 119.

Camera 112 may be any type of device used to record images or videos that can be stored locally and/or transmitted to another location to be stored. These images may be still photographs or moving images such as videos. Camera 112 may operate to record images during daytime and during nighttime and may rely on ambient and environmental lighting, make use of night vision technology, and/or have its own light source for low-light imaging.

Microphone 114 may be any device that may record, store and/or play back sounds, including sounds recorded in nature. The sounds may be stored locally and/or transmitted to another location to be stored. The sounds may be recorded in analog or digitally and in any known medium.

Locating system 119 may be any device that may be used to locate the position of the observation device 110, such as a GPS, RTLS, or local position system (LPS). Locating system 119 may use beacons such as a cellular data base, Wi-Fi access points, radio broadcast towers, satellites, or any other known elements to determine the geographical location of observation device. Locating system 119 may also include a memory configured to receive and store information about the geographical positioning of observation device 110. If observation device 110 is relocated or moved, locating system 119 may determine a new geographical position of observation device 110 and store data associated with the position within observation device 110 and/or transmit the data to a remote location.

Transmitter 116 may be any device capable of transmitting communications from observation device 110 to a computing device 120 over network 130. The transmitted communications may be delivered in any known medium such as AM radio waves, FM radio waves, infrared short-range communications, Wi-Fi, or any other known type of wireless telecommunications medium. In one embodiment, transmitter 116 may be configured to transmit the images recorded by camera 112 and sounds recorded by microphone 114 in real time to a remote location along with the data associated with the position of observation device 110. Transmitter 116 may be configured to transmit the images recorded by camera 112 in a first medium such as Wi-Fi, while the sounds recorded by microphone 114 may be transmitted in a second medium such as FM radio. In another embodiment, transmitter 116 may be configured to transmit the images recorded by camera 112 and the sounds recorded by microphone 114 in both the first and second mediums. In one specific embodiment, transmitter 116 may deliver sounds and images of wild birds and nature recorded by camera 112 and microphone 114 wirelessly over a distance of up to 40 meters to a designated speaker display. The sounds may be transmitted wirelessly via FM transmission to regular FM band radio. Transmitter 118 may also operate at a unique frequency or address, thus eliminating noise for a transmitted signal. In further embodiments, transmitter 118 may also include a receiver, such that it is capable of receiving an FM or other signal.

Power source 118 may be any device that is configured to provide electric power to camera 112, microphone 114 and/or transmitter 116. In one embodiment power source 118 may be a battery or a combination of batteries, such as a 3 volt, 4.5 volt, 6 volt, and/or 9 volt combination. Battery 118 may also include a solar charging unit configured to cover observation device 110 and to convert sunlight into electricity. The solar charging unit may be configured to recharge the batteries within power source 118 and/or power the observation device 110 directly. Therefore, power source 118 may be a self-sustaining power source for observation device 110.

Computing device 120 may be a computer with a processor such as a computer, smart phone, tablet computer, etc. Computing device 120 may be configured to receive and store the transmitted communications from observation device 110, and may upload the transmitted communications onto a website 122 in real time. In one embodiment, the website 112 may be a social networking site or any other type of website allowing remote users to observe the sights and sounds recorded in real time by camera 112 and microphone 114 at observation device 110. The website 112 may also be configured to present data associated with the geographic position of observation device 110 as determined by the locating system 119. Therefore, people viewing website 112 may be able to know the location of the birds, animals and/or nature being observed by observation device 110. In one embodiment, website 112 may include an interface that allows users to remotely record images and sounds from observation device 110. The recorded data may then be played back at any desired time the users who recorded them and/or by any user viewing website 112. One skilled in the art will appreciate that a plurality of users may simultaneously view website 112 and simultaneously play back the same or different recorded data at the same time.

Speaker 140 may be a device that produces sound in response to an electrical audio signal input. Speaker 140 may be configured to be located inside a consumer's home, and may include receiver 145. Receiver 145 may be any device configured to receive data and convert the data into a usable form. In one embodiment, receiver 145 may include an antenna to receive the data over any known medium such as AM radio waves, FM radio waves, infrared short-range communications, Wi-Fi, or any other known type of wireless telecommunications medium.

Specifically, receiver 145 may be configured to receive data transmitted by transmitter 116 over network 130. Transmitter 116 may be configured to transmit data at a unique frequency, address (e.g. MAC or IP address) or with any other type of identifier and receiver 145 may be configured to receive the data from transmitter 116 at the unique frequency, address or identifier. The unique identifier may be an FM radio frequency, AM radio frequency, IP address, or any other type of identification. Therefore, if there are multiple observation devices and paired speakers in close proximity to each other, each such pair will have a transmitter and receiver configured to communicate data with unique signals, so the signals do not cause interference with other pairings. In other words, an observation device and a designated speaker pair are programmed to use a unique individual address so there is no interference caused by the communicated signals, even if two neighbors each with an observation device live next to each other. In one embodiment, observation device 110 may be placed on top of or coupled to an existing feeder and support. Camera 112 and microphone 114 may be positioned to record and store the activity taking place at the feeder. Therefore, if birds congregate at the feeder, observation device 110 may observe the birds. The recorded activity of the birds may then be transmitted over a network 130 and be uploaded to a computing device 120 and/or website 122 in real time and/or in bursts. Therefore, users all over the world may simultaneously view the activities taking place at the feeder in real time.

In one embodiment, a hand-held, battery-operated wireless remote may be used to turn on and off power source 118. Therefore, the observation device 110 may be remotely turned on and off. In one specific embodiment, the remote may operate to turn the observation device 110 on and off from a distance of up to 40 meters, a distance sufficient for many users to control an observation device 110 in the user's yard from inside the user's house.

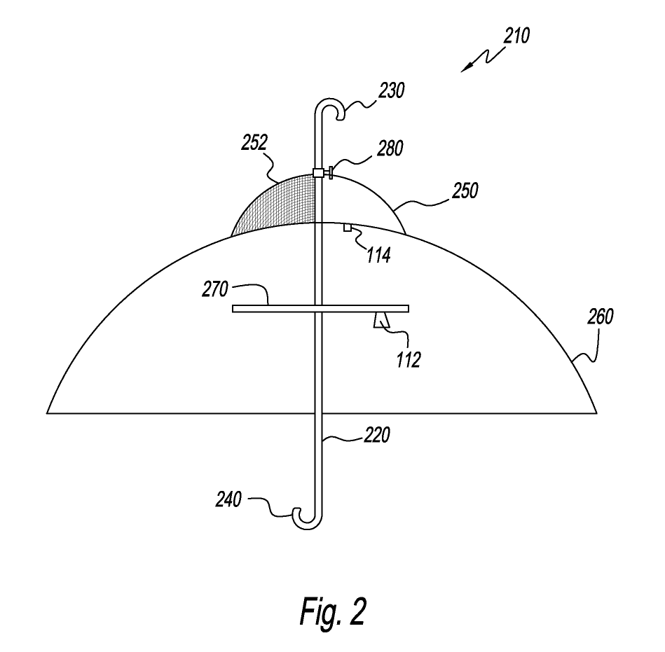

FIG. 2 depicts an illustration of an observation device 210 according to an embodiment.

Observation device 210 may include rod 220, first hook 230, second hook 240, first dome 250, second dome 260, slide bar 270, slide lock 280, camera 112 and microphone 114.

First and second domes 250, 260 may be housings. First dome 250 may be configured to be placed over or on top of second dome 260. First dome 250 may be a UV-treated housing.

First dome 250 may house electronics such as microphone 114, power source 118, and transmitter 116. In an embodiment, first dome 250 may be UV-resistant PVC and be 5 mm in thickness. On a surface of first dome 250 may be solar charging unit 252 configured to convert sunlight into electricity. Solar charging unit 252 may be solar panels or a solar mesh configured to charge the batteries within observation device 210 or observation device 210 itself. In one embodiment, first dome 250 may have a 5 inch base diameter and be 4 inches tall. First dome 250 may be configured to disposed on top of and/or adjacent to second dome 260. If slide lock 280 is fastened, first dome 250 may be configured to be coupled to second dome 260. When slide lock 280 is unfastened, first dome 250 may be free to slide up rod 220 away from second dome 260 for servicing or the like. By coupling first dome 250 to second dome 260, the electrical components within first dome 250 may be safely housed without exposure to the environment. One skilled in the art will appreciate that first dome 250 may be any shape or size, such as a box, cylinder, etc. Furthermore, in embodiments the first dome 250 may be inside second dome 260 rather than above it. In such embodiments first dome 250 may have a protective bottom surface to prevent animals from damaging the electronics therein.

Second dome 260 may be a UV-treated housing. In an embodiment second dome 260 may be UV-resistant PVC and be 5 mm in thickness. In one embodiment, the second dome 260 may have a 16 inch base diameter and be 7 inches tall. Second dome 260 may also include a UV treated surface. Second dome 260 may be configured so that any sized bird feeder may be disposed under second dome 260. As such, second dome 260 may be substantially larger that first dome 250. One skilled in the art will appreciate that second dome 260 may be any shape or size, such as a box, cylinder, etc, and that the dimensions of second 260 may be any size. For example, second dome may have a 10 inch, 12 inch or 14 inch base.

Second dome 260 may be configured to house slide bar 270 and camera 112. Slide bar 270 may be configured to be coupled to camera 112. A length of slide bar 270 may be smaller than a diameter of second dome 260. Slide bar 270 may be configured to be disposed perpendicular to rod 220 and within second dome 260 and may slide through or adjacent to rod 220 and/or be rotated within second dome 260.

As such, if rod 220 is rotated, slide bar 270 will be correspondingly rotated, or if slide bar 270 is slid within rod 220, camera 112 may record images with different fields of view. In one embodiment, slide bar 270 may have a thumb screw locking device (not shown). If the thumb screw locking device is tightened, slide bar 270 and camera 112 may be held in place, and if the thumb screw locking device is released, camera 112 and slide bar 270 may slide back and forth to change the field of view of the camera 112 so as to allow users to better see wild birds feeding. In another embodiment, slide bar 270 may be fixed or only rotationally movable and camera 112 may slide along the fixed slide bar to change its position. The slide bar 270 allows for a one-size-fits-all approach, where the observation device can be customized for use with any existing feeder or other animal attraction by adjusting the slide bar/camera to get a good view of the animals or other natural objects of interest. In one embodiment, slide bar 270 may be configured to slide and swivel within rod 220 and may also include a telescopic arm (not shown), which camera 112 may be disposed on. The telescopic arm may be able to extend and/or be compressed to change the field of view of camera 112.

Rod 220 may extend above first dome 250 and below second dome 260, and be configured to couple first dome 250 and second dome 260. Rod 220 may be a substantially straight rod with first hook 230 disposed on one end and second hook 240 disposed on a second end. In one embodiment rod 220 may be attached via twist and lock telescoping mechanisms (not shown) to be positioned at different height adjustments. If the twist and lock telescoping mechanism is loosened then rod 220 may be extended or collapsed. Upon extending the telescoping mechanism to a desired length, the twist and lock mechanism can be tightened to secure the length of rod 220. One skilled in the art will appreciate that instead of first hook 230 and second hook 240 any known coupling mechanism may be used, such as loops, rings, etc. First hook 230 may be configured to be coupled to a tree, post or any other structure that can support the weight of observation device 210 and a feeder. Second hook 240 may be configured to be coupled to a feeder. By coupling first hook 230 to a support structure and second hook 240 to an existing feeder, observation device 210 may be easily coupled to any existing feeder, eliminating the cost of a custom-made feeder tailored to work with the observation system.

Slide lock 280 may be positioned on top of first dome 250. Slide lock 280 may include a thumb screw and lock, and be configured to secure the first dome 250 in place adjacent to second dome 260. The thumb screw may be tightened so that first dome 250 is coupled and secured to rod 220, or the thumb screw may be loosened so that first dome 250 may be moved apart from second dome 260 by sliding first dome 250 along rod 220. More specifically, if the thumb screw is loosened, slide lock 280 may be released so that first dome 250 may be moved away from second dome 260 to access the electronics within first dome 250.

In an embodiment, second dome 260 may also include a locking mechanism (not shown) to couple second dome 260 to rod 220. If the locking mechanism is released, then second dome 260 may slide along rod 220, and if the locking mechanism is tightened then second dome 260 may be secured to rod 220. Therefore, second dome 260 may be positioned at any location along rod 220, and first dome 250 may be positioned on top of second dome 260. The domes protect the other elements of the system from the environment.

In one embodiment, a transmitter (not shown) may be disposed within first dome 250 and be capable of transmitting communications from observation device 210 to a computing device and/or directly to a website. The transmitted communications may be delivered in any known medium such as AM radio waves, FM radio waves, infrared short-range communications, Wi-Fi, etc. In one embodiment, transmitter may be configured to transmit the images recorded by camera 112 and sounds recorded by microphone 114 in real time to a remote location (i.e. the computer or website). In one embodiment, the website may be a social networking site or any other type of website allowing remote users to observe the sights and sounds recorded by camera 112 and microphone 114 at observation device 210, respectively, in real time. Therefore, users are not required to be located at the observation device 210 to enjoy nature in close proximity to the observation device.

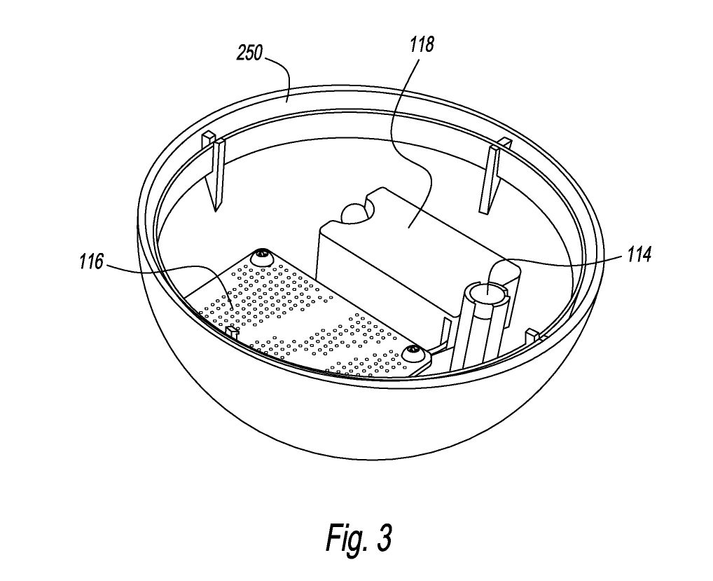

FIG. 3 depicts a perspective view of first dome 250 according to an embodiment. As depicted, first dome 250 may include power source 118, microphone 114, and a digital circuit board that may include a processor and an antenna capable for transmitter 116 to transmit stored or recorded audio and video to a remote location. Each of the components within first dome 250 may be securely fastened or coupled within first dome 250 to be held in place either via screws, male and female snaps, or any other known fastening mechanisms.

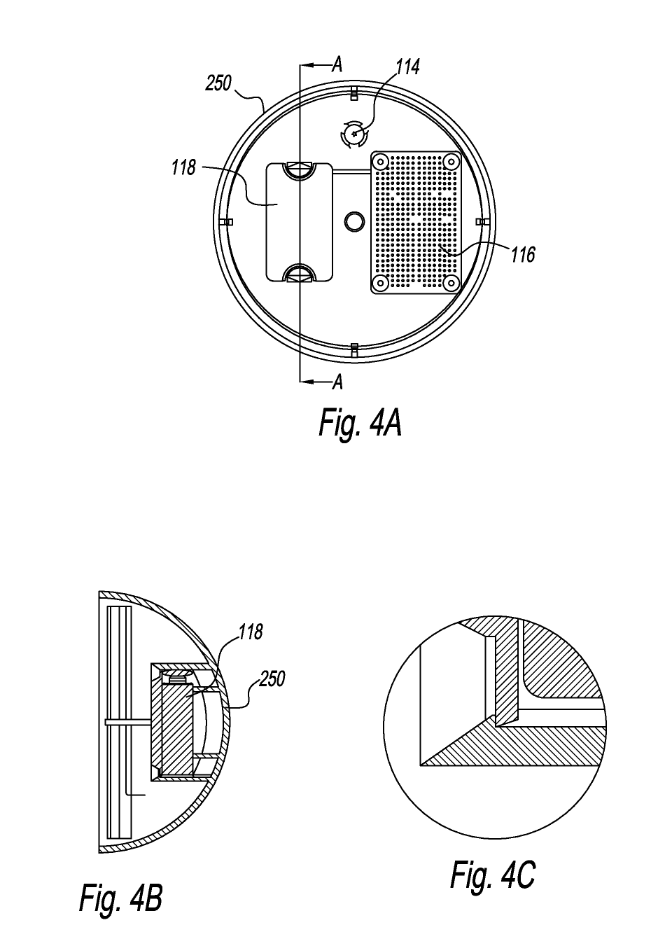

FIGS. 4A-C depict a various views of first dome 250. FIG. 4A depicts a bottom view of a first dome 250 including power source 118, microphone 114, and a digital circuit board that may include a processor and an antenna capable for transmitter 116 to transmit stored or recorded audio and video to a remote location. FIG. 4B depicts a cross-sectional view of first dome 250 including power source 118. FIG. 4C depicts a detailed view of a portion of cross sectional view 4B showing the opening of power source 118 in a secured closed position.

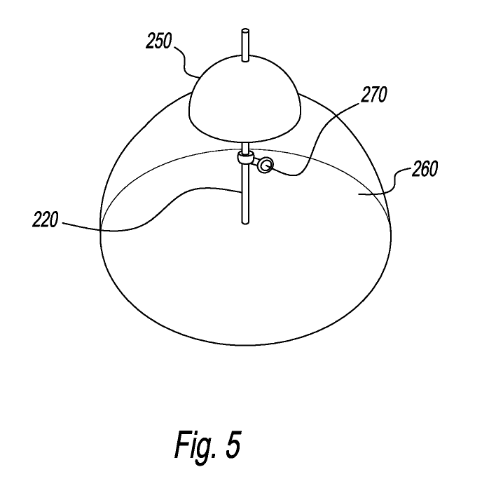

FIG. 5 depicts a perspective view of first dome 250 and second dome 260 according to an embodiment. As one skilled in the art will appreciate, first dome 250 may be substantially smaller than second dome 260. Further, second dome 260 may be a transparent material.

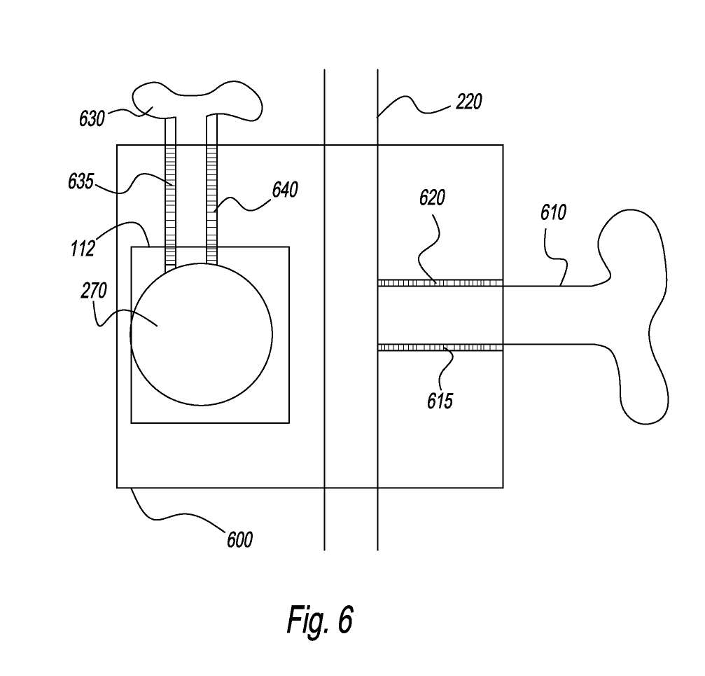

FIG. 6 depicts a housing 600 for slide bar 270 according to an embodiment. Housing 600 may be a plastic material, which may be transparent. Housing 600 may be removably attached to rod 220 via a threaded screw 610. Housing 600 may have an internal thread 615 positioned on a side of housing 600 and horizontal to rod 220. Threaded screw 610 may have external thread 620 configured to be received by internal thread 615. If screw 610 is tightened then housing 600 may be attached to rod 220, and if screw 610 is loosened, then housing 600 may be released and removed from rod 220.

Housing 600 may also be configured to house slide bar 270. Slide bar 270 may be positioned perpendicular to rod 220, and be positioned on an opposite side of housing 600 as threaded screw 610. Slide bar 270 may also be configured to slide and be repositioned within housing 600 by releasing and tightening threaded screw 630. On a surface of housing 600 that is perpendicular to internal thread 615, housing 600 may include internal thread 640. Internal thread 640 may be configured to receive external thread 635 of screw 630. If screw 620 is tightened then sliding bar 270 may be attached to housing 600, and if screw 630 is loosened, then slide bar 270 may be released and slid to a different position within housing 600. By sliding slide bar 270 within housing 600, the field of view of camera 112, which may be attached to slide bar 270, may correspondingly be changed.

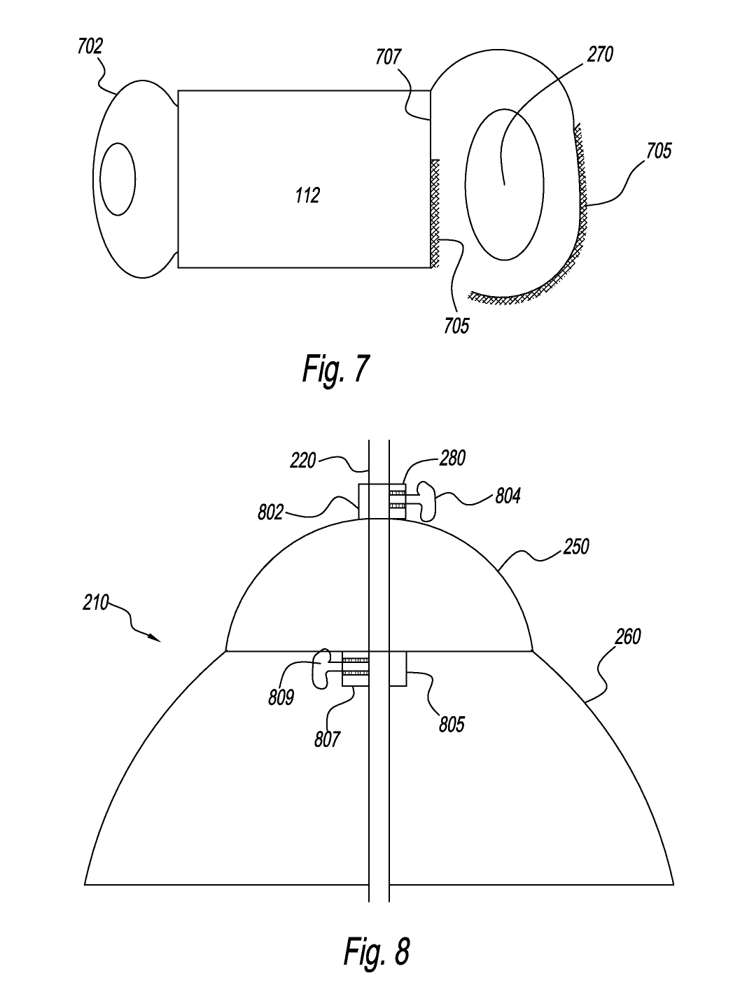

FIG. 7 depicts a camera 112 attached to slide bar 270 according to one embodiment. A first portion 705 of a loop and hook locking system, may be positioned on an outer surface of slide bar 270. In one embodiment, first hook-and-loop portion 705 may be positioned substantially on lower hemisphere of rod 270. On a surface of camera 112 opposite of lens 702 may be a second portion 707 of the loop and hook locking system. Hook and loop portion 707 may be configured to be coupled with hook and loop portion 705 to secure camera 112 on slide bar 270 (after tightening first portion 705 around slide bar 270). One skilled in the art would appreciate that Velcro 707 may be coupled and uncoupled to Velcro 705 so that camera 112 may be positioned and secured at different locations along slide bar 270 and/or at different angles with respect to slide bar 270. By positioning camera 112 at different locations along slide bar 270 and/or at different angles, lens 702 of camera 112 may view different fields of view.

FIG. 8 depicts one embodiment of an observation device with threaded screw locking mechanisms 280 and 805. Screw locking mechanism 280 may be positioned above first dome 250 along rod 220, and include a housing with an internal thread 802 and a screw 804 with an external thread. Screw 804 may be configured to couple with the internal thread of housing 802 to secure first dome 250 along rod 220. By releasing screw locking mechanism 280 first dome 250 may be removed from rod 220.

Screw locking mechanism 805 may be configured to be positioned at a top portion of second dome 260, and directly below first dome 250 along rod 220. Screw locking mechanism 805 may include a housing with an internal thread 807 and a screw 809 with an external thread. Screw 809 may be configured to couple with the internal thread of housing 807 to secure second dome 260 to rod 220 directly below first dome 250. By releasing screw locking mechanism 805 second dome 260 may be removed from rod 220 and separated from first dome 250.

Advantages described herein allow a double housing observation device to be quickly and easily hooked up to any existing feeder. The observation device may be able to store and record images and sounds at the feeder, and then transmit the images and sounds to a remote location where they may be uploaded in real time to a website or to a social networking site. Therefore, users all over the world will be able to enjoy the sounds and sights of wild birds and nature at an existing feeder, without the need of purchasing an additional custom made feeder.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments. While the embodiments may be illustrated by using a particular embodiment, this is not and does not limit the invention to any particular embodiment and a person of ordinary skill in the art will recognize that additional embodiments are readily understandable and are a part of the example embodiments.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What I claim is:

1. A nature observation system comprising:
one or more housings containing a camera, a transmitter and a microphone; and
a rod with first and second coupling mechanisms, the rod being configured to extend below and above the housings, the first coupling mechanism being configured to couple to a support structure and the second coupling mechanism being configured to couple to a bird feeder;
wherein the camera is configured to record images of nature, the microphone is configured to record sounds of nature, and the transmitter is configured to transmit the recorded sounds and images to a remote location.

2. The nature observation system of claim 1, wherein the one or more housings comprise a first housing contains the microphone and transmitter and a second, adjacent housing contains the camera.

3. The nature observation system of claim 1, wherein the first housing is releasably secured to an upper surface of the second housing.

4. The nature observation system of claim 1, wherein the camera is disposed on a slide bar, the slide bar being configured to slide back and forth and/or rotate with the camera attached to change a field of view of the camera.

5. The nature observation system of claim 4, wherein the slide bar is configured to allow the camera to slide along the slide bar to change the field of view of the camera.

6. The nature observation system of claim 2, wherein the first housing is secured in place against the second housing via a locking mechanism.

7. The nature observation system of claim 6, wherein loosening the locking mechanism allows the first housing to slide along the rod to be separated from the second housing.

8. The nature observation system of claim 1, wherein at least a portion of an outer surface of the housings includes a solar charging unit, and the housings further contain a battery, wherein the battery is configured to be charged by the solar charging unit.

9. The nature observation system of claim 3, wherein the first housing is a first dome and the second housing is a second dome, the first dome being smaller than the second dome.

10. The nature observation system of claim 1, wherein the transmitted sounds and images are transmitted in real time.

11. The nature observation system of claim 1, wherein the transmitted sounds and images are uploaded to a website in real time.

12. The nature observation system of claim 1, wherein the housings further comprise a locator configured to regularly determine a physical location of the housings, and wherein the transmitter is configured to transmit the determined physical location to a remote location.

13. The nature observation system of claim 1, wherein the housings further comprise a locator configured to regularly determine a physical location of the housings, and wherein the transmitter is configured to transmit the determined physical location to a remote location.

14. The nature observation system of claim 1, further comprising a speaker remote from the housings and comprising a receiver configured to receive sounds transmitted by the transmitter for playback.

15. The nature observation system of claim 14, wherein the transmitter is configured to transmit data with a unique identifier and the receiver is configured only to receive data with the unique identifier.

16. The nature observation system of claim 1, further comprising a computing device comprising a processor and a non-transitory computer-readable medium configured to carry out the operation comprising:
receiving recorded images and sounds from the transmitter;
displaying the received images on a display;
playing the received sounds via a speaker; and
storing at least some of the received images and/or sounds for later playback.

17. The nature observation system of claim 16, wherein the operation further comprises receiving requests from a plurality of remote users to view the received images and/or hear the received sounds, and transmitting the requested images and/or sounds along with location information of the housings to the remote users.

18. The nature observation system of claim 2, further comprising a locking mechanism securing the second housing to the rod.

19. The nature observation system of claim 4, further comprising a slide bar housing comprising recesses for receiving the slide bar and the rod, and locking mechanisms for preventing movement of the slide bar and rod within the recesses.

20. A nature observation method, comprising:
coupling a system to a supporting structure, wherein the system comprises:
one or more housings containing a camera, a transmitter and a microphone; and
a rod with first and second coupling mechanisms, the rod being configured to extend below and above the housings, the first coupling mechanism being configured to couple to the support structure and the second coupling mechanism being configured to couple to a bird feeder;
wherein the camera is configured to record images of nature, the microphone is configured to record sounds of nature, and the transmitter is configured to transmit the recorded sounds and images to a remote location;
coupling a bird feeder to the second coupling mechanism;
disposing the camera on a slide bar and positioning the slide bar to provide a field of view to the camera that covers the area surrounding the bird feeder;
determining a location of the system using a locator;
recording sounds and images near the bird feeder using the camera and microphone;
transmitting the recorded sounds and images and the location of the system to a remote location with a unique identifier; and
playing back the recorded sounds and images with the unique identifier at the remote location for the enjoyment of remote users.
